(19) United States
(12) Patent Application Publication
(10) Pub. No.: US 2025/0289183 A1
(43) Pub. Date: Sep. 18, 2025

(54) Disassembly and Assembly Universal Type Filament Reel for 3D Printing Filaments and Use Method

(71) Applicant: Guangdong Biying Zengcai Manufacturing Technology Co., Ltd., Huizhou (CN)

(72) Inventor: Youliang Peng, Lianyuan (CN)

(21) Appl. No.: 19/080,760

(22) Filed: Mar. 14, 2025

(30) Foreign Application Priority Data
Mar. 18, 2024 (CN) 2024103063186

(51) Int. Cl. B29C 64/321; B29C 64/118; B33Y 40/00

(52) U.S. Cl. CPC B29C 64/321; B29C 64/118; B33Y 40/00

(57) ABSTRACT

A disassembly and assembly universal type filament reel for 3D printing filaments includes a reel body and two reel members. The reel body is a connection barrel with openings at its two ends. The reel body is located between the two reel members, and external filaments are wound around the reel body. The two reel members are respectively detachably rotatably clamped with the reel body or the two reel members are detachably rotatably clamped with each other.

### CROSS-REFERENCE TO RELATED APPLICATIONS

The present application claims the benefit of Chinese Patent Application No. 202410303618.6 filed on Mar. 18, 2025, the contents of which are hereby incorporated by reference.

### TECHNICAL FIELD

The present invention relates to the technical field of 3D printing filament reels, and particularly discloses a disassembly and assembly universal type filament reel for 3D printing filaments and use method.

### TECHNICAL BACKGROUND

Ordinary printers are used to print flat objects designed by computers in daily life, while the so-called 3D printers share the same working principle as ordinary printers, except that the printing materials are slightly different. Ordinary printers use ink and papers as printing materials, while the 3D printers are equipped with metal materials, ceramics, plastic, sand, and so on as printing materials. The printing materials of the 3D printers are stacked layer by layer under the control of computer, and finally the blueprint on the computer is turned into a physical object. In other words, a 3D printer is used to print out three dimensions objects not flat objects.

With the popularization of 3D printing technology, users consume an increasing of large amounts of 3D printing materials, among which Fused Deposition Modeling printing has gradually become the mainstream. The consumables used in Fused Deposition Modeling 3D printing material is a reel-type filaments. Sellers generally sell a set of filament with a set of filament reel together. The filament reel takes up a large space and has a lot of weight, which makes it inconvenient to pack and transport, and results in a high transportation cost. When the filaments are used up, the reel is directly discarded, resulting in a waste of resources and environmental pollution.

### Invention Content

In order to overcome the shortcomings and defects of the prior art, the purpose of the present invention is to provide a universal type filament reel which is easy to assemble and dissemble, and can be recycled.

To achieve the above-mentioned purpose, the present invention discloses a disassembly and assembly universal type filament reel for 3D printing filaments including a reel body and two reel members. The reel body is a connection barrel with openings at its two ends. The reel body is located between the two reel members, and the external filaments are wound around the reel body. The two reel members are respectively detachably rotatably clamped with the reel body or the two reel members are detachably rotatably clamped with each other. In this way, the reel body and the filaments for printing can be replaced quickly, and the two reel members and the reel body can be reused, so as to reduce the production cost; at the same time, the reel body and the two reel members can be packaged and transported separately to reduce transportation cost.

Further, the disassembly and assembly universal type filament reel also includes a barrel portion arranged on the first reel member. The first reel member and the barrel portion are an integrated structure, and the barrel portion is placed inside the reel body. A plurality of blocks are arranged on the end of the barrel portion away from the first reel member, and a plurality of slots adapted to the blocks are arranged on the second reel member. The barrel portion is rotatably clamped with the second reel member via the plurality of blocks and slots. The barrel portion is placed inside the reel body wound with filaments, so that the reel body can be replaced quickly and easily, and the reel member can be utilized fully to reduce the production cost.

Further, two ends of the reel body are also provided with a plurality of blocks, and a plurality of slots adapted to the blocks are arranged on the first reel member and second reel member. The reel body is rotatably clamped with the two reel members via the plurality of blocks and the slots, resulting in an effect of quickly detaching the reel body and replacing external filaments.

Further, a limited block is respectively arranged on the inner side of each block. A flange is arranged on the center of each reel member, and a plurality of slots are arranged on the outer peripheral side wall of each flange, and a plurality of limited cavities are arranged on the plurality of slots. Each block is connected to one correspondingly slot, and the limited blocks are clamped in the plurality of limited cavities to prevent the reel body separating from the two reel members. In this way, the filament reel can be assembled quickly to save time and improve production efficiency.

Further, the first and second reel members are respectively provided with a first through hole, and the first through holes are used to observe the consumption of the filaments to determine whether the filaments are consumed and facilitate timely replacement of the filaments.

Further, two ends of the reel body are provided with U shape notches, and a plurality of second through holes are correspondingly arranged on the two reel members. The U shape notches are adapted to the plurality of second through holes to calibrate the installation of the two reel members. Whether the two reel members are installed in place is judged by whether the U shape notches are aligned with the second through holes, so as to avoid the reel body being unstable in releasing the filaments and affecting the printing effect due to the two reel members not being installed in place.

Further, a sliding guide inclined surface is arranged on the end of each block away from the limited block, and the sliding guide inclined surface facilitates the limited blocks entering and exiting the slots.

Further, two ends of the limited block are respectively set with a chamfer to facilitate the limited blocks smoothly entering or moving out of the slots of the reel members.

Further, a plurality of threading holes are arranged on the edge of the reel member, and two or more reel members can be tied together with ropes through the threading holes in transportation.

The use method of disassembly and assembly universal type filament reel for 3D printing filaments includes steps as following: Step 1: install the two reel members at two ends of the reel body wound with filaments, or detachably clamp the two reel members on two ends of the reel body, and then place the assembled filament reel in a 3D printer for use; Step 2: when run out of filaments, take out the assembled filament reel from the 3D printer, and disassemble the two reel members from the reel body; Step 3: install the two reel members on another reel body wound with filaments, and then place the new assembled filament reel in the 3D printer for use again.

The beneficial effects of the present invention are as follows: the two reel members are respectively detachably rotatably clamped with the reel body, so that the reel body and the filaments for printing can be replaced quickly, and the two reel members and the reel body can be reused, so as to reduce the production cost; at the same time, the reel body and the reel members can be packaged and transported separately to reduce the transportation cost; the reel body and the two reel members are rotatably clamped with each other, so that the reel body can be disassembled and assembled quickly. Thus, the filament reel for 3D printing filaments with good versatility is convenient to disassemble and assemble, so as to improve production efficiency.

### DESCRIPTION OF FIGURES

FIG. 1 is a schematic structural view of a disassembly and assembly universal type filament reel for 3D printing filaments of the present invention;

FIG. 2 is an exploded view of the disassembly and assembly universal type filament reel for 3D printing filaments of the present invention;

FIG. 3 is a schematic cross-sectional view of a reel body of the present invention;

FIG. 4 is a schematic structural view of a reel member of the present invention;

FIG. 5 is a partial view of A in FIG. 2;

FIG. 6 is a partial view of B in FIG. 3;

FIG. 7 is an exploded view of Embodiment II of the disassembly and assembly universal type filament reel for 3D printing filaments of the present invention.

Description of marks in figures:
reel body 2—reel member 3—first through hole
4—block 5—slot 6—limited block
7—flange 8—limited cavity 9—U shape notch
10—second through hole 11—sliding guide inclined surface 12—chamfer
13—threading hole 14—barrel portion

### DETAILED DESCRIPTION OF THE EMBODIMENTS

In order to further explain the technical means and effects adopted by the present invention to achieve the predetermined invention purpose, the specific implementation mode, structure, characteristics and effects of the present invention are described in detail below in combination with the attached drawings and preferred embodiments.

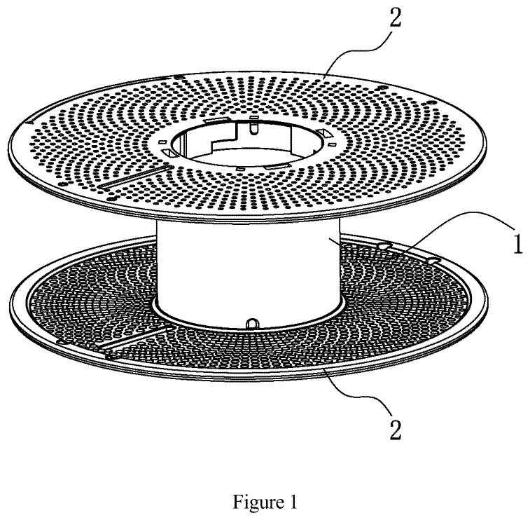

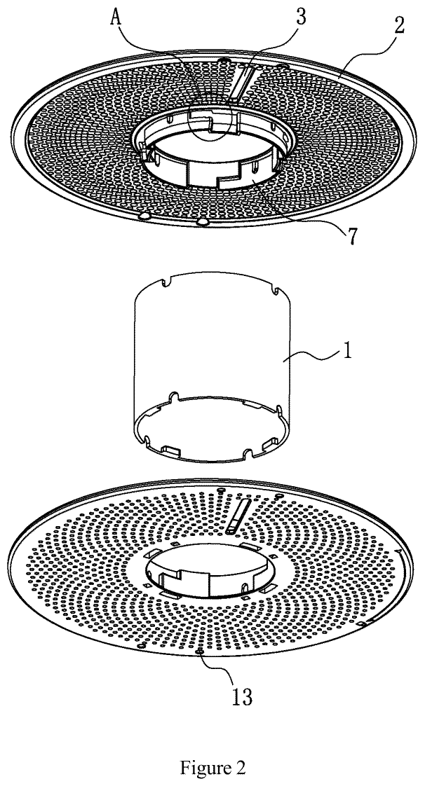

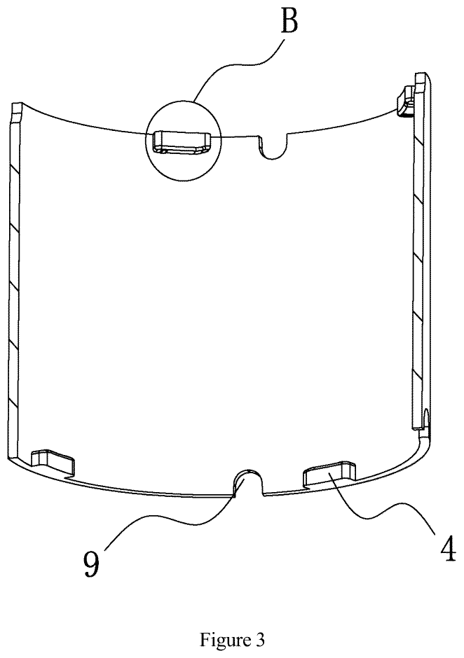

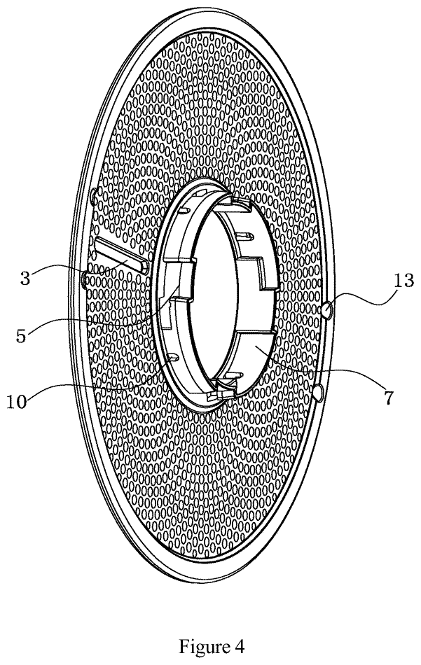

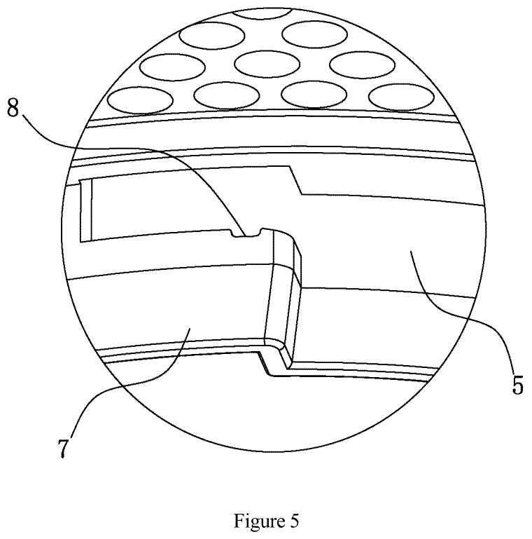

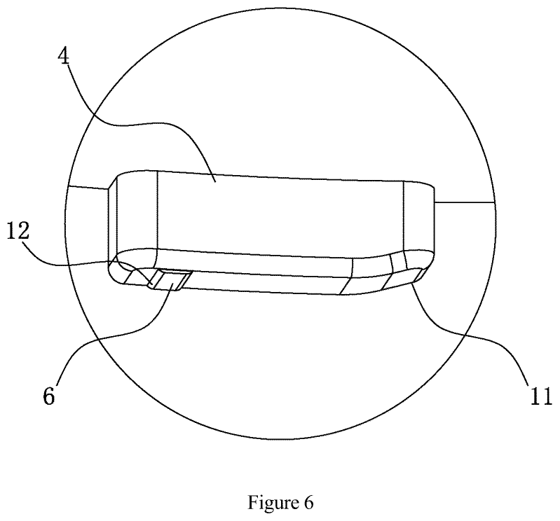

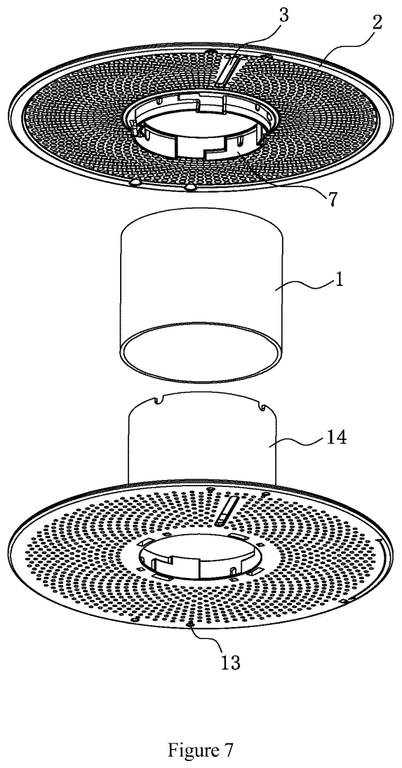

According to FIGS. 1 to 7, the disassembly and assembly universal type filament reel for 3D printing filaments of the present invention includes a reel body 1 and two reel members 2. The reel body 1 is a connection barrel with openings at its two ends. The reel body 1 is located between the two reel members 2, and the external filaments are wound around the reel body 1; the two reel members 2 are respectively detachably rotatably clamped with the reel body 1 or the two reel members 2 are detachably rotatably clamped with each other. In this way, the reel body 1 and the filaments for printing can be replaced quickly, and the two reel members 2 and the reel body 1 can be reused, so as to reduce the production cost; at the same time, the reel body 1 and the two reel members 2 can be packaged and transported separately to reduce the transportation cost.

In Embodiment I, two ends of the reel body 1 are also provided with a plurality of blocks 4, and a plurality of slots 5 adapted to the blocks 4 are arranged on the first reel member 2 and second reel member 2. The reel body 1 is rotatably clamped with the two reel members 2 via the plurality of blocks 4 and slots 5, resulting in an effect of quickly detaching the reel body and replacing external filaments.

In Embodiment II, the said disassembly and assembly universal type filament reel also includes a barrel portion 14 arranged on the first reel member 2. The first reel member 2 and the barrel portion 14 are an integrated structure, and the barrel portion 14 is placed inside the reel body 1; a plurality of blocks 4 are arranged at the end of the barrel portion 14 away from the first reel member 2, and a plurality of slots 5 adapted to the blocks 4 are arranged on a second reel member 2. And the barrel portion 14 is rotatably clamped with the second reel member 2 via the plurality of blocks 4 and slots 5. When in use, the barrel portion 14 is placed inside the reel body 1 wound with filaments, so that the reel body 1 can be replaced quickly and easily, and the reel members 2 can be utilized fully to reduce production cost.

A limited block 6 is respectively arranged on the inner side of each block 4, a flange 7 is arranged on the center of each reel member 2; a plurality of slots 5 are arranged on the outer peripheral side wall of each flange 7, and a plurality of limited cavities 8 are arranged on the plurality of slots 5; each block 4 is connected to one correspondingly slot 5, and the limited blocks 6 are clamped in the plurality of limited cavities 8 to prevent the reel body 1 separating from the two reel members 2. The limited blocks 6 are clamped in the limited cavities 8 to prevent the barrel body separating from the reel body, so as to achieve the purpose of rapid assembly to save time and improve production efficiency.

The first reel member 2 and the second reel member 2 are respectively provided with a first through hole 3, and the first through holes 3 are used to observe the consumption of the filaments.

The two ends of the reel body 1 are provided with U shape notches 9, and a plurality of second through holes 10 are correspondingly arranged on the two reel members 2. The U shape notches 9 are adapted to the plurality of second through holes 10 to calibrate the installation of the two reel members 2.

A sliding guide inclined surface 11 is arranged on the end of each block 4 away from the limited block 6. The sliding guide inclined surface 11 facilitates the limited blocks 6 entering and exiting the slots 5.

Two ends of each limited block 6 are respectively set with a chamfer 12 to facilitate the limited blocks 6 smoothly entering into or moving out of the slots 5 of the reel members 2.

A plurality of threading holes 13 are arranged on the edge of the reel member 2, and two or more reel members 2 can be tied together with ropes through the threading holes 13 in transportation.

Further, the first through hole 3 is configured as an elongated strip, and the length direction of the first through hole 3 is arranged along the diameter direction of the reel member 2.

Further, a scale value is set on the side surface of the length direction of the first through hole 3, and the scale value is used to indicate the remaining length of the filaments, so as to facilitate accurate judgment of the remaining filament amount.

Further, a through hole is arranged at the center of the reel member 2, and users can extend an external rod body into the reel body 1 through the through hole, so as to facilitate fixing the reel members 2 through the rod body.

Further, the reel member 2 is provided with hollow holes penetrating the wall of the reel member 2, and the hollow holes are distributed in a circular array around the central axis of the through hole. The hollow holes can reduce the weight of the reel body to save materials and reduce production cost.

Further, an annular groove is arranged on an inner side of the reel member 2, and the annular groove is used to limit the movement of the filaments to prevent the filaments from slipping out of the filament reel when the filaments are released.

The use method of the disassembly and assembly universal type filament reel for 3D printing filaments includes steps as following: Step 1: install the two reel members 2 on two ends of the reel body 1 wound with filaments, or rotatably clamp the two reel members 2 on two ends of the reel body 1, and then place the assembled filament reel in a 3D printer for use; Step 2: when run out of filaments, take out the assembled filament reel from the 3D printer, and disassemble the two reel members 2 from the reel body 1; Step 3: install the two reel members 2 on another reel body 1 wound with filaments, and then place this new assembled filament reel in the 3D printer for use again.

Further, after the two reel members 2 are disassembled in Step 2, the reel body 1 can be wound with filaments and used again.

Further, rib reinforcements are arranged on an edge of the reel member 2. The thickness of the rib reinforcement is greater than the thickness of the wall of the reel member 2. And the rib reinforcements are used to strengthen the overall structural strength of the reel member 2 to prevent the reel member 2 from deforming during use or transportation.

In Embodiment I, two reel members 2 are rotatably clamped on the two ends of the reel body 1 wound with filaments. The blocks 4 on the reel body 1 extend into the slots 1 on the two reel members 2, and two reel members 2 are rotated forward to make the limited blocks 6 engage with the limited cavities 8. Then the assembled filament reel is placed into a 3D printer for use. The consumption of the filaments is observed through the first through hole 3. After the filaments are run out, the assembled filament reel is taken out from the 3D printer, and the two reel members 2 are rotated in the opposite direction to move the limited blocks 6 out of the limited cavities 8, so that the two reel members 2 are separated from the two ends of the reel body 1. And the two reel members 2 are detachably installed on another reel body 1 wound with filaments, and then this new assembled reel body 1 is placed into the 3D printer for use again.

In Embodiment II, the barrel portion 14 is placed inside the reel body 1 wound with the filaments. The blocks 4 at the end of the barrel portion 14 away from the first reel member 2 extend into the slots 5 of the second reel member 2. The second reel member 2 is rotated forward to make the limited blocks 6 clamped with the limited cavities 8. The assembled filament reel is put into the 3D printer for use. The consumption of the filaments is observed through the first through hole 3. After the filaments are run out, the assembled filament reel is taken out from the 3D printer, the second reel member 2 is reversely rotated to move the limited blocks 6 out of the limited cavities 8, so that the second reel member 2 is separated from the barrel portion 14. Then the barrel portion 14 is placed into another reel body 1 wound with the filaments, and the second reel member 2 is detachably installed on the barrel portion 14, finally the new assembled filament reel is placed into the 3D printer for use again.

The above description is only a preferred embodiment of the present invention and does not limit the present invention in any form. Although the present invention has been disclosed as a preferred embodiment as above, it is not used to limit the present invention. Any technical personnel in this field can make some changes or modify the technical contents disclosed above into equivalent embodiments without departing from the scope of the technical solution of the present invention. However, any brief modifications, equivalent changes and modifications made to the above embodiments based on the technical essence of the present invention without departing from the content of the technical solution of the present invention are still within the scope of the technical solution of the present invention.

1. A disassembly and assembly universal type filament reel for 3D printing filaments comprises a reel body and two reel members, wherein the reel body is a connection barrel with openings at its two ends; the reel body is located between the two reel members, and the external filaments are wound around the reel body; the two reel members are respectively detachably rotatably clamped with the reel body or the two reel members are detachably rotatably clamped with each other.

2. The disassembly and assembly universal type filament reel for 3D printing filaments according to claim 1, wherein the said universal type filament reel further comprises a barrel portion arranged on a first reel member, the first reel member and the barrel portion are an integrated structure, and the barrel portion is placed inside the reel body; a plurality of blocks are arranged at an end of the barrel portion away from the first reel member, and a plurality of slots adapted to the blocks are arranged on a second reel member, and the barrel portion is rotatably clamped with the second reel member via the plurality of blocks and slots.

3. The disassembly and assembly universal type filament reel for 3D printing filaments according to claim 1, wherein two ends of the reel body are also provided with the plurality of blocks, and the plurality of slots adapted to the blocks are arranged on the first reel member and second reel member; the reel body is rotatably clamped with the two reel members via the plurality of blocks and slots, resulting in an effect of quickly detaching the reel body and replacing external filaments.

4. The disassembly and assembly universal type filament reel for 3D printing filaments according to claim 2, wherein a limited block is respectively arranged on an inner side of each block, a flange is arranged on a center of each reel member; a plurality of slots are arranged on an outer peripheral side wall of each flange, and a plurality of limited cavities are arranged on the plurality of slots; each block is connected to one correspondingly slot, and the limited blocks are clamped in the plurality of limited cavities to prevent the reel body separating from the two reel members.

5. The disassembly and assembly universal type filament reel for 3D printing filaments according to claim 1, wherein the first and second reel members are respectively provided with a first through hole, and the first through holes are used to observe a consumption of the filaments.

6. The disassembly and assembly universal type filament reel for 3D printing filaments according to claim 1, wherein two ends of the reel body are provided with U shape notches, and a plurality of second through holes are correspondingly arranged on the two reel members; the U shape notches are adapted to the plurality of second through holes to calibrate an installation of the two external reel members.

7. The disassembly and assembly universal type filament reel for 3D printing filaments according to claim 6, wherein a sliding guide inclined surface is arranged on an end of each block away from the limited block.

8. The disassembly and assembly universal type filament reel for 3D printing filaments according to claim 6, wherein two ends of the limited block are respectively provided with a chamfer to facilitate the limited blocks smoothly entering or moving out of the slots of the reel members.

9. The disassembly and assembly universal type filament reel for 3D printing filaments according to claim 5, wherein a plurality of threading holes are arranged on an edge of the reel member, and two or more reel members can be tied together with ropes through the threading holes in transportation.

10. A use method of the disassembly and assembly universal type filament reel for 3D printing filaments includes steps as following:
Step 1: install the two reel members on two ends of the reel body wound with filaments, or detachably clamp the two reel members on two ends of the reel body, and then place the assembled filament reel in a 3D printer for use;
Step 2: when run out of filaments, take out the assembled filament reel from the 3D printer, and disassemble the two reel members from the reel body;
Step 3: install the two reel members on another reel body wound with filaments, and then place this new assembled filament reel in the 3D printer for use again.
